(19) United States
(12) Patent Application Publication
(10) Pub. No.: US 2014/0132213 A1
(43) Pub. Date: May 15, 2014

(54) BATTERY MANAGEMENT SYSTEM AND ELECTRIC VEHICLE

(71) Applicant: VIA TECHNOLOGIES, INC., New Taipei City (TW)

(72) Inventor: Tze-Shiang WANG, New Taipei City (TW)

(73) Assignee: VIA TECHNOLOGIES, INC., New Taipei City (TW)

(21) Appl. No.: 14/056,570

(22) Filed: Oct. 17, 2013

(30) Foreign Application Priority Data
Nov. 12, 2012 (TW) 101141989

(51) Int. Cl. B60L 11/18

(52) U.S. Cl. CPC B60L 11/1816
USPC 320/109

(57) ABSTRACT

A battery management system for use in an electric vehicle is provided. The battery management system has: a battery module, configured to provide power to drive the electric vehicle; and a charging module, configured to detect a type of a USB device coupled to the battery management system, and charge the USB device by using power from the battery module according to the type of the USB device.

### CROSS REFERENCE TO RELATED APPLICATIONS

This Application claims priority of Taiwan Patent Application No. 101141989, filed on Nov. 12, 2012, the entirety of which is incorporated by reference herein.

### BACKGROUND OF THE INVENTION

1. Field of the Invention

The present invention relates to a battery management system, and in particular to a battery management system for use in an electric vehicle (e.g. electric bikes, electric motorcycles, or cars).

2. Description of the Related Art

Currently, an electric vehicle may comprise a battery module and a battery management system. The present USB devices may have different types of charging specifications, and the required maximum charging currents of different charging specifications may be different. Although the conventional battery management system of an electric vehicle provides a charging function to charge a USB device, the conventional battery management system can not recognize the type of the USB device, and thus the USB device connected to the conventional battery management system can only be charged with a fixed charging current. Accordingly, it is not effective to charge a USB device by using the conventional battery management system.

### BRIEF SUMMARY OF THE INVENTION

A detailed description is given in the following embodiments with reference to the accompanying drawings.

In an exemplary embodiment, a battery management system for use in an electric vehicle is provided. The battery management system comprises: a battery module, configured to provide power to drive the electric vehicle; and a charging module, configured to detect a type of a USB device coupled to the battery management system, and charge the USB device by using the power from the battery module according to the type of the USB device.

In another exemplary embodiment, an electric vehicle is provided. The electric vehicle comprises: a battery module, configured to provide power to the electric vehicle; a driving apparatus, configured to receive the power from the battery module to drive the electric vehicle; and a charging module, configured to detect a type of a USB device coupled to the battery management system, and charge the USB device by using the power from the battery module according to the type of the USB device.

### BRIEF DESCRIPTION OF THE DRAWINGS

The present invention can be more fully understood by reading the subsequent detailed description and examples with references made to the accompanying drawings, wherein:

FIG. 1A is a simplified schematic diagram of a battery management system according to an embodiment of the invention;

FIG. 1B is a schematic diagram illustrating the charging module 130 according to an embodiment of the invention;

FIGS. 2A and 2B represent a flow chart illustrating a USB device detection method according to an embodiment of the invention;

FIG. 3 is a circuit diagram illustrating the voltage detection circuit according to an embodiment of the invention; and

FIG. 4 is a simplified schematic diagram illustrating an electric vehicle according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

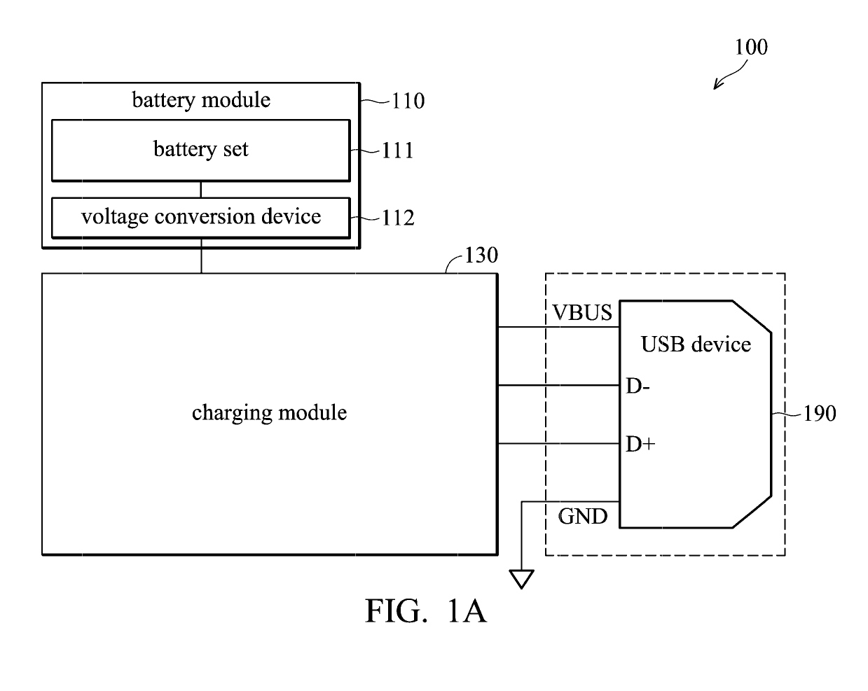

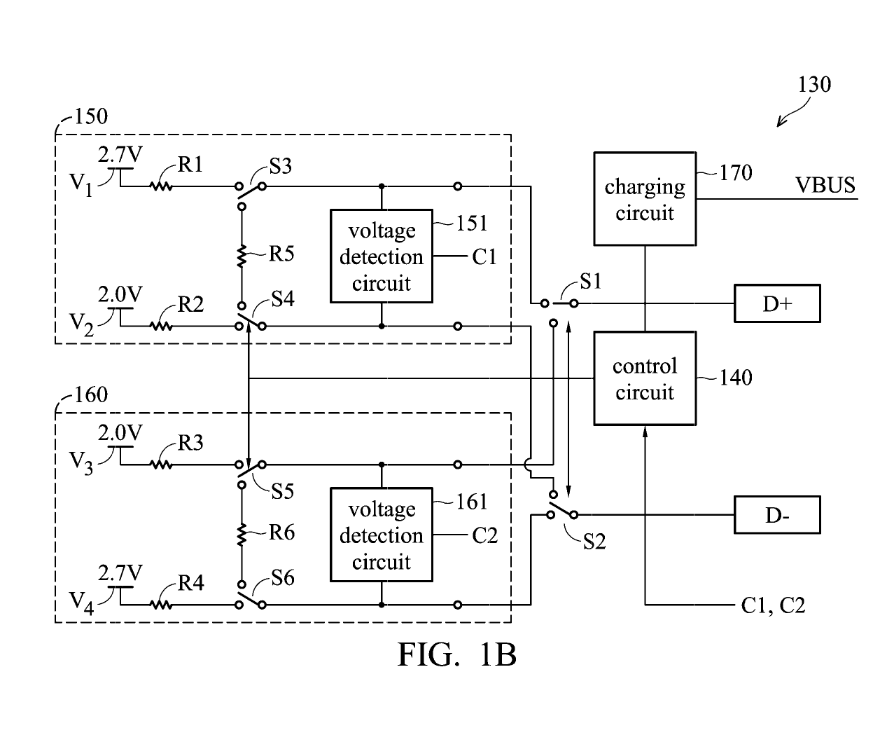

FIG. 1A is a simplified schematic diagram of a battery management system according to an embodiment of the invention. The battery management system 100 is for use in an electric vehicle (e.g. an electric motorcycle, an electric bicycle or a car), and the battery management system 100 at least comprises a battery module 110 and a charging module 130. In an embodiment, the battery module 110 may comprise a battery set 111 and a voltage conversion device 112. The battery set 111 may comprise multiple batteries (not shown in FIG. 1A) and a voltage conversion device 112. In an embodiment, the batteries in the battery set 111 can be electrically connected in series connection, parallel connection, or parallel-serial connection. Thus, if the battery set 111 has a high output voltage (e.g. 48V or 36V), the voltage conversion device 112 may convert the output voltage of the battery set 111 to a lower operation voltage (e.g. 5V) for supplying the charging module 130. In addition, the battery module 110 may also output an appropriate voltage and current as the power to drive the aforementioned electric vehicle.

The charging module 130, coupled to the battery module 110, is configured to detect the type of the USB device 190 connected to the battery management system 100 automatically, and provide an optimal voltage/current to charge the USB device 190 with the power from the battery module 110 according to the detected type of the USB device 190.

In an embodiment, the charging module 130 may transmit a feature signal corresponding to a specific type to the USB device 190 when the USB device is connected to the battery management system 100, and detect the type of the USB device 190 according to a voltage level from the USB device 190 in response to the feature signal. Specifically, the charging module 130 may transmit a first feature signal corresponding to a first type to the USB device 190 when the USB device 190 is connected to the battery management system 100. Then, the charging module 130 may detect whether the USB device 190 conforms to the first type according a voltage level from the USB device 190 in response to the first feature signal. When the USB device 190 conforms to the first type, the charging module 130 may provided a first charging current to charge the USB device 190. When the USB device 190 does not conform to the first type, the charging module 130 may transmit a second feature signal corresponding to a second type to the USB device 190. Then, the charging module 130 may further determine whether the USB device conforms to the second type according to the voltage level from the USB device 190 in response to the second feature signal. When the USB device 190 conforms to the second type, the charging module 130 may provide a second charging current to charge the USB device 190. When the USB device 190 does not conform to the second type, the charging module 130 may further provide a third charging current corresponding to a third type to charge the USB device 190.

In an embodiment, the aforementioned first type and second type are model numbers or type numbers defined by a specific manufacturer (e.g. iPad, New iPad, or iPhone defined by Apple), but the invention is not limited thereto. The aforementioned first type and second type can be other model numbers or type numbers defined by other specific manufacturers, such as Blackberry, Samsung, or other brands. In addition, the aforementioned first charging current and second charging current may be 1 A and 2 A, respectively. In another embodiment, the aforementioned third type may be a model supporting the dedicated charging port (hereinafter as DCP) mode defined in the USB Battery Charging Specification (hereinafter as USB BCS). In addition, the aforementioned third charging current may be 1.5 A.

When a USB device is connected to a conventional charging module, the conventional charging module may use the standard downstream port (hereinafter as SDP) mode defined in the USB BCS to charge the USB device with a 0.5 A current without concern for what type of the USB device it is. Thus, there may be the issue of a long charging time for the conventional charging module. However, the charging module 130 may provide an appropriate current larger than 0.5 A to charge the USB device 190 according to the type of USB device 190, thereby achieving fast charging of the USB device 190. It should be noted that the voltage level of the differential signal pair (e.g. D+ and D− pins) of the USB device 190 should be set to a fixed specific voltage level when the USB device 190 is charged by a current larger than the current defined in the SDP mode (e.g. 0.5 A). Since there is no demand for data transmission during the charging of the USB device on the electric vehicle, the battery management system 100 may set the voltage level of the differential signal pair (e.g. D+ and D− pins) of the USB device 190 to a fixed voltage level when the USB device 190 is charged by the battery management system 100, so that it is more convenient for the battery management system 100 to select one of the first, second and third charging current to charge the USB device 190.

FIG. 1B is a schematic diagram illustrating the charging module 130 according to an embodiment of the invention. In an embodiment, the charging module 130 may comprise a control circuit 140, a first detection circuit 150, a second detection circuit 160, and a charging circuit 170. When a USB device (not shown in FIG. 1B) is connected to the battery management system 100 of the invention, the control circuit 140 may control the connection states among the USB device, the first detection circuit 150 and the second detection circuit 160, so that the type of the USB device can be detected by the first detection circuit 150 or the second detection circuit 160. Specifically, the control circuit 140 may control switches S1 and S2, so that the first detection circuit 150 is coupled to the differential signal pair (e.g. D+ and D− pins in FIG. 1B) of the USB device. The first detection circuit 150 may transmit a first feature signal to the differential signal pair of the USB device, and detect whether a voltage level in the response from the USB device is the same with the first feature signal by using a voltage detection circuit 151, thereby determining whether the USB device conforms to the first type. According to the determination result of the first type, the control circuit 140 may control the charging circuit 170 to charge the USB device with the first charging current. Or the control circuit 140 may control the switches S1 and S2 again, so that the second detection circuit 160 is coupled to the differential signal pair of the USB device. When the second detection circuit 160 is coupled to the USB device, the second detection circuit 160 may transmit a second feature signal to the differential signal pair of the USB device, and detect whether the voltage level in the response from the USB device is the same with the second feature signal by using the voltage detection circuit 161, thereby determining whether the USB device conforms to the second type. According to the determination result of the second type, the control circuit 140 may control the charging circuit 170 to charge the USB device with the second charging current or the third charging current. In an embodiment, the control circuit 140 may be a microcontroller, a processor, or other equivalent logic circuits, but the invention is not limited thereto.

In an embodiment, the control circuit 140 may control the switches S3 and S1, so that the voltage source V1 having a first voltage level (e.g. 2.7V) is coupled to the D+ pin of the USB device. Meanwhile, the control circuit 140 may control the switches S4 and S2, so that the voltage source V2 having a second voltage level (e.g. 2.0V) is coupled to the D− pin of the USB device. Accordingly, the first detection circuit 150 may transmit the first feature signal by providing the first voltage level (e.g. 2.7V) and the second voltage level (e.g. 2.0V) to the differential signal pin (e.g. D+ and D− pins) respectively. When the USB device conforms to the first type and has received the first feature signal, the USB device may respond with voltage signals of 2.7V and 2.0V at the D+ pin and the D− pin, respectively. The voltage detection circuit 151 may determine whether the USB device conforms to the first type by detecting whether the voltage levels of the D+ and D− pins are the same with the 2.7V and 2.0V respectively, and store the determination result of the first type into a first register (not shown) by a control signal C1. Then, the control circuit 140 may read the data stored in the first register to perform corresponding actions, such as charging the USB device with the first charging current, or perform subsequent detection by the second detection circuit 160.

In another embodiment, the control circuit 140 may control the switches S5 and S1, so that the voltage source V3 having a third voltage level (e.g. 2.0V) is coupled to the D+ pin of the USB device. Meanwhile, the control circuit 140 may control the switches S6 and S2, so that the voltage source V4 having a fourth voltage level (e.g. 2.7V) is coupled to the D− pin of the USB device. Accordingly, the second detection circuit 160 may transmit the second feature signal by providing the third voltage level (e.g. 2.0V) and the fourth voltage level (e.g. 2.7V) to the differential signal pair (e.g. D+ and D− pins) respectively. When the USB device conforms to the second type and has received the second feature signal, the USB device may respond with respective voltage signals at 2.0V and 2.7V at the D+ pin and D− pin respectively. The voltage detection circuit 161 may determine whether the USB device conforms to the second type by detecting whether the voltage levels of the D+ and D− pins are the same with the 2.0V and 2.7V respectively. The detection circuit 161 may further store the determination result of the second type into a second register (not shown) by a control signal C2. Then, the control circuit 140 may read the data stored in the second register to perform corresponding actions, such as charging the USB device with the second charging current or the third charging current.

In view of the above, the control circuit 140 may control the charging circuit 170 to output an appropriate current through the VBUS pin of the USB device according to the type of USB device 190 detected by the first detection circuit 150 or the second detection circuit 160. The voltage detection circuit 151 in the first detection circuit 150 and the voltage detection circuit 161 in the second detection circuit 160 are configured to detect the voltage levels in response from the USB device, thereby determining whether the USB device conforms to the first type (e.g. Apple devices charged with a 2 A current) or the second type (e.g. Apple devices charged with a 1 A current). When the USB device does not conform to the first type and the second type, the control circuit 140 may control the charging circuit 170 to charge the USB device with a third charging current.

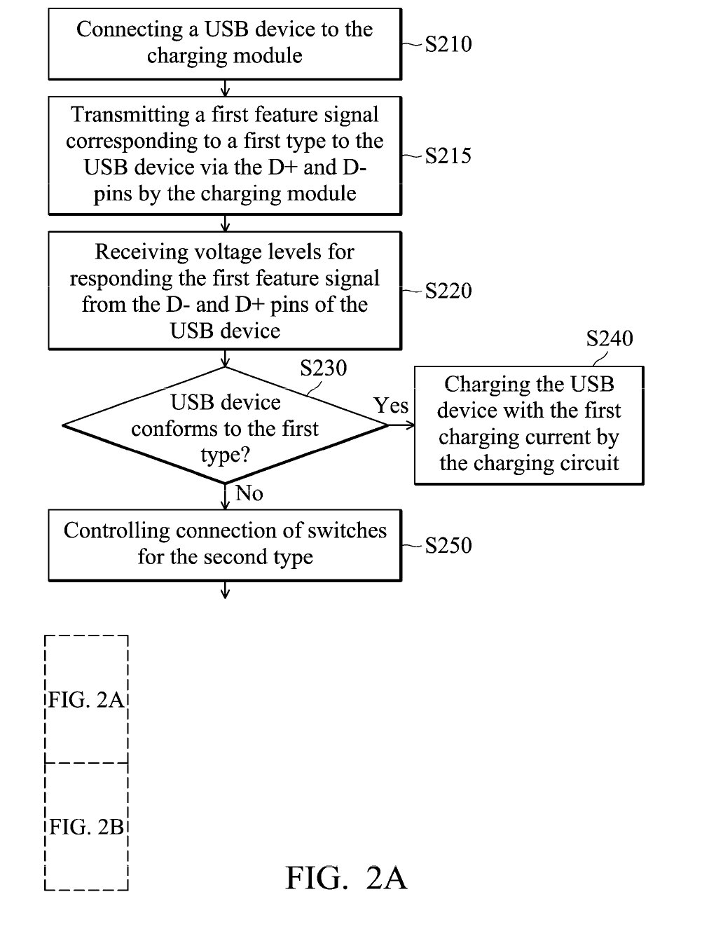

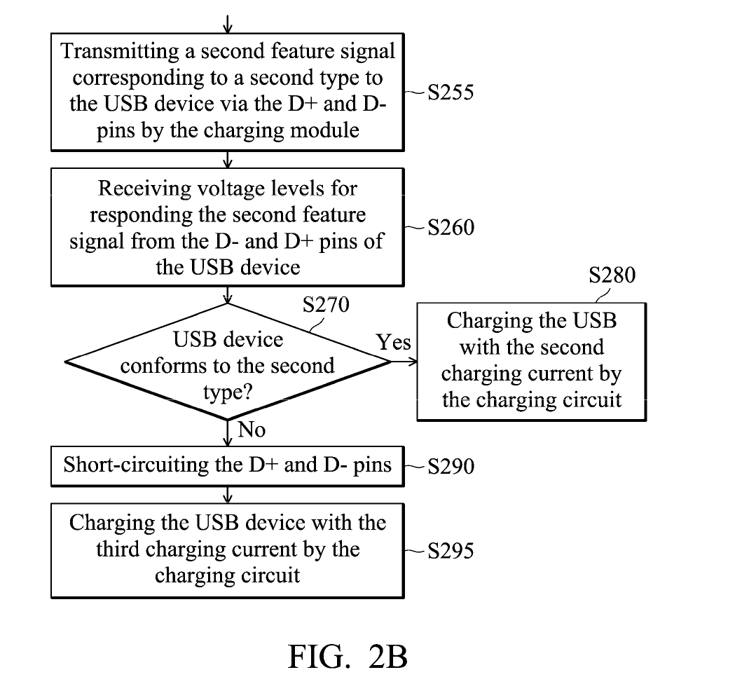

FIG. 2 is a flow chart illustrating a USB device detection method according to an embodiment of the invention. Referring to FIG. 1A-1B and FIG. 2, detailed operations of each detection circuit of the charging module 130 in the invention are described in the following embodiments. The control circuit 140 may enter a first charging mode having a first charging current (e.g. 2 A), a second charging mode having a second charging current (e.g. 1 A), or a third charging mode (e.g. DCP mode) by the control signals C1 and C2 from the voltage detection circuits 151 or 161. In addition, the control circuit 140 firstly determines whether the USB device can be charged by the first charging mode having the first charging current, but the invention is not limited thereto. Alternatively, the control circuit 140 may also firstly determine whether the USB device can be charged by the second charging mode having the second charging current, or in the DCP mode as a default charging mode.

For example, in the second charging mode (e.g. 1 A charging mode), the voltage levels of the D+ and D− pins are at 2.0V and 2.7V, respectively. In the first charging mode (e.g. 2 A charging mode), the voltage levels of the D+ and D− pins are at 2.7V and 2.0V, respectively. In the following embodiment, the first charging mode having the 2 A current is regarded as the default charging mode for the purpose of description. When a USB device 190 is connected to the battery management system 100 through a USB interface (e.g. D+, D−, GND, and VBUS pins in FIG. 1A) (step S210), the charging module 130 is in the first charging mode in the beginning, and the control circuit 140 may control the switches S1 and S2 to select the first detection circuit 150, and control the switches S3 and S4 to connect to the respective voltage sources V1 and V2. That is, the D+ pin and the D− pin are connected to the voltage source V1 (e.g. 2.7V) and the voltage source V2 (e.g. 2.0V), respectively. After the charging module 130 has transmitted a first feature signal corresponding to a first type (e.g. first charging mode having a 2 A current) to the D+ and D− pins of the USB device 190 (step S215). The charging module 130 may receive the voltage levels for responding the first feature signal from the D+ and D− pins of the USB device 190 (step S220). Then, the voltage detection circuit 151 of the first detection circuit 150 may determine whether the responding voltage levels from the D+ and D− pins are the same with the first feature signal (e.g. the voltage levels at D+ and D− pins are 2.7V and 2.0V, respectively). That is, the first detection circuit 150 may determine whether the USB device 190 conforms to the first type (step S230). If so (e.g. the responding voltage levels are the same with the first feature signal), it is determined that the USB device supports the first charging mode, and the charging circuit 170 may charge the USB device 190 with the first charging current (e.g. 2.0 A) at the VBUS pin. If not, step S250 is performed.

In step S250, the control circuit 140 may control the switches S1 and S2 to select the second detection circuit 160, and control the switches S5 and S6 to connect to the voltage sources V3 and V4, respectively. That is, the D+ and D− pins are connected to the voltage source V3 (e.g. 2.0V) and the voltage source V4 (e.g. 2.7V). The charging module 130 may transmit the second feature signal corresponding to a second type (e.g. 1 A charging mode) to the D+ and D− pins of the USB device 190 (step S255). The charging module 130 may also receive the voltage levels for responding to the second feature signal from the D+ and D− pins of the USB device 190 (step S260). Then, the voltage detection circuit 161 of the second detection circuit 160 may determine whether the responding voltage levels from the D+ and D− pins of the USB device 190 are the same with the second feature signal (i.e. determining whether the responding voltage levels at the D+ and D− pins are 2.0V and 2.7V, respectively). That is, the second detection circuit 160 may determine whether the USB device 190 conforms to the second type (step S270). If so (e.g. the responded voltage levels are the same with the second feature signal), it is determined that the USB device 190 supports the second charging mode, and the charging circuit 170 may charge the USB device 190 with the second charging current (e.g. 1.0 A) via the VBUS pin. If not, step S290 is performed.

In step S290, since the USB device 190 does not support the first charging mode (e.g. 2 A charging mode) or the second charging mode (e.g. 1 A charging mode), the control circuit 140 may short-circuit the D+ pin and the D− pin, such that the D+ pin and the D− pin have the same voltage level. In the present embodiment, the control circuit 140 may control the switches S1 and S2 to select the first detection circuit 150, and control the switches S3 and S4 to connect to a resistance R5, so that the D+ pin and the D− pin are short-circuited. In addition, the control circuit 140 may optionally control the switches S1 and S2 to select the second detection circuit 160, and control the switches S5 and S6 to connect to a resistance R6, so that the D− pin and the D+ pin are short-circuited. Meanwhile, the charging circuit 170 may provide the third charging current (e.g. 1.5 A) through the VBUS pin to charge the USB device 190 (step S295). Generally, there is no demand for data transmission when the USB device 190 is being charged in an electric vehicle. Thus, the charging module 130 may short-circuit the D+ and D− pins which are used for data transmission, so that the USB device 190 can be charged in the third charging mode with the third charging current which is larger than the charging current (e.g. 0.5 A for USB 2.0, and 0.7 A for USB 3.0) defined in the SDP mode. The aforementioned third charging mode may be the DCP mode or another specific charging mode for the USB devices defined by other specific manufacturers. When the USB device 190 is charged in the DCP mode or another specific charging mode defined by other specific manufacturers, the voltage levels of the D+ and D− pins of the USB device 190 should be set to a specific fixed voltage level respectively. Accordingly, the D+ pin and the D− pin are short-circuited in step S290, and thus the voltage level of the D+ pin is identical to that of the D− pin, so that the USB device 190 can be charged with the third charging current, which is greater than the current defined in SDP mode, in step S295. Note that although the charging circuit 170 provides the third charging current at the VBUS pin to charge to the USB device 190, the charging current received by the USB device 190 still depends on the limitation of the charging mode defined by the USB interface specification of the USB device 190. For example, the USB device 190 may only support the SDP mode without supporting the DCP mode. Although the third charging current provided by the charging module 130 is greater than the charging current supported by the SDP mode, the maximum value of the charging current for charging the USB device 190, which only supports the SDP mode, is 0.5 A. Only when the USB device 190 supports the DCP mode, the maximum value of the charging current can be raised to 1.5 A. In addition, when the D− and D+ pins are short-circuited and the USB device 190 has been charged via the charging current (e.g. 1.5 A) of the DCP mode for more than a predetermined time period (e.g. 10 seconds), the control circuit 140 may restore the switches S1˜S6 to the connections of the default charging mode (e.g. 1 A charging mode or 2 A charging mode). That is, D+ and D− pins are restored to the connections of the default charging mode. Meanwhile, the charging circuit 170 may still keep charging the USB device 190 without affecting by the connection restoration of the switches S1˜S6 by the control circuit 140.

It should be noted that the 2 A charging mode is regarded as the default charging mode in the aforementioned embodiment. Alternatively, the 1 A charging mode can also be regarded as the default charging mode, and reference can be made to steps S250˜S280 in the aforementioned embodiment for the details of the procedure. In another embodiment, steps S210˜S240 or S250˜S280 in FIG. 2 can be optionally omitted. That is, the charging current provided to the USB device 190 can be switched between a default charging mode (e.g. 2 A charging mode or 1 A charging mode) and the DCP charging mode according to the detected type of the USB device 190.

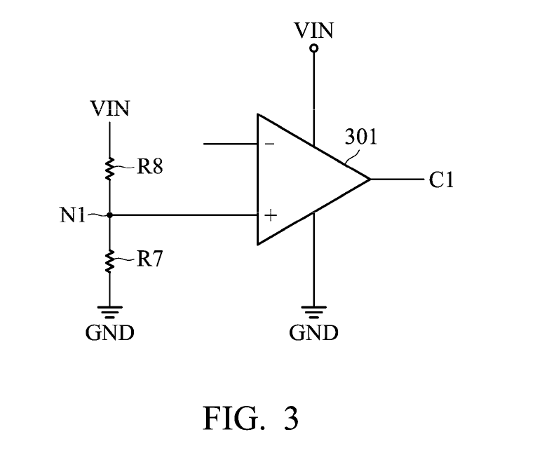

FIG. 3 is a circuit diagram illustrating the voltage detection circuit according to an embodiment of the invention. Referring to both FIG. 1B and FIG. 3, the voltage detection circuit 151 of the first detection circuit 150 or the voltage detection circuit 161 of the second detection circuit 160 can be implemented by using a comparator, as illustrated in FIG. 3. An input terminal (e.g. the positive input terminal) of the amplifier 301 may receive a reference voltage, and another input terminal (e.g. the negative input terminal) of the amplifier 301 may receive an input voltage to be compared (e.g. the voltage level from the D− pin or D+ pin of the USB device 190). The voltage level of the VIN pin is fixed, such as 5V, and thus a desired reference voltage (e.g. 2.0V or 2.7V) can be obtained at a node N1 by adjusting the resistance ratio of the resistances R7 and R8. For those skilled in the art, it is understood that there are various ways to implement a comparator by using an amplifier and the details will not be described here. Generally, the difference of the voltage levels between the D− pin and the D+ pin should be large enough, thereby determining the charged mode for the USB device explicitly.

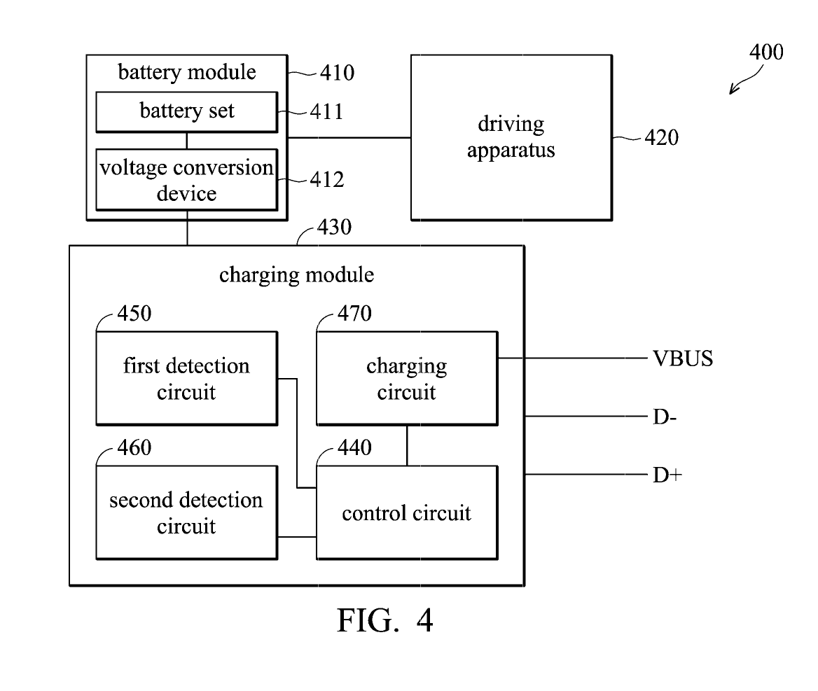

FIG. 4 is a simplified schematic diagram illustrating an electric vehicle according to an embodiment of the invention. In an embodiment, the electric vehicle 400 at least comprises a battery module 410, a driving apparatus 420, and a charging module 430. In an embodiment, the battery module 410 may comprise a battery set 411 and a voltage conversion device 412. The voltage conversion device 412 may convert the output voltage of the battery set 411 to a first operation voltage (e.g. 5V) required by the charging module 430 and a second operation voltage (e.g. 48V) required by the driving apparatus 420. The driving apparatus 420 may be an electric motor for driving the electric vehicle 400. The charging module 430 may comprise a control circuit 440, a first detection circuit 450, a second detection circuit 460, and a charging circuit 470. Reference can be made to the corresponding embodiments of FIG. 1B for the details of the aforementioned components 440˜470, and the details will not be described here.

In view of the above, the battery management system 100 may recognize the type of USB device, and provide a more appropriate charging current to charge the USB device according to the recognized type. Since the battery management system can be applied to an electronic vehicle, there is no demand for transmitting differential packets at the differential signal pair (e.g. D− and D+ pins) of the USB device when the USB device is charged by the battery management system of the electric vehicle of the invention. Accordingly, the battery management system of the invention may provide a corresponding fixed voltage on the differential signal pair, and provide a larger charging current at the VBUS pin of the USB interface to charge the USB device. In addition, the battery management system of the invention may directly charge the USB device without entering a “suspend” status.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A battery management system for use in an electric vehicle, comprising
a battery module, configured to provide power to drive the electric vehicle; and
a charging module, configured to detect a type of a USB device coupled to the battery management system, and charge the USB device by using the power from the battery module according to the type of the USB device.

2. The battery management system as claimed in claim 1, wherein the charging module transmits a feature signal corresponding to a specific type to a differential signal pair of the USB device, and detects the type of USB device according to a voltage level from the differential signal pair in response to the feature signal.

3. The battery management system as claimed in claim 1, wherein the charging module comprises:
a first detection circuit, configured to determine whether the USB device conforms to a first type;
a control circuit; and
a charging circuit, wherein when the USB device conforms to the first type, the control circuit directs the charging circuit to charge the USB device with a first charging current.

4. The battery management system as claimed in claim 3, wherein the first detection circuit provides a first voltage level and a second voltage level to a differential signal pair of the USB device, and determines whether the USB device conforms to the first type by detecting whether voltage levels in the response from the differential signal pair of the USB device are the same with the first voltage level and the second voltage level respectively.

5. The battery management system as claimed in claim 3, wherein the charging module further comprises a second detection circuit, and the second detection circuit determines whether the USB device conforms to a second type when the USB device does not conform to the first type,
wherein the control circuit further directs the charging circuit to charge the USB device with a second charging current when the USB device conforms to the second type,
wherein the control circuit further directs the charging circuit to charge the USB device with a third charging current when the USB device does not conform to the second type.

6. The battery management system as claimed in claim 5, wherein the second detection circuit provides a third voltage level and a fourth voltage level to the differential signal pair of the USB device, and determines whether the USB device conforms to the second type by detecting whether voltage levels in the response from the differential signal pair of the USB device are the same with the third voltage level and the fourth voltage level respectively.

7. The battery management system as claimed in claim 5, wherein the control circuit further short-circuits the differential signal pair when the USB does not conform to the second type, and directs the charging circuit to enter a dedicated charging port mode to charge the USB device with the third charging current through a VBUS pin of the USB device.

8. The battery management system as claimed in claim 5, wherein the control circuit further restores the differential signal pair to a connection corresponding to the first type when the charging circuit has charged the USB device with the third charging current for more than a predetermined time period.

9. The battery management system as claimed in claims 2, wherein the differential signal pair comprises a D+ pin and a D− pin.

10. The battery management system as claimed in claims 4, wherein the differential signal pair comprises a D+ pin and a D− pin.

11. An electric vehicle, comprising:
a battery module, configured to provide power for the electric vehicle;
a driving apparatus, configured to receive the power from the battery module to drive the electric vehicle; and
a charging module, configured to detect a type of a USB device coupled to the battery management system, and charge the USB device by using the power from the battery module according to the type of the USB device.

12. The electric vehicle as claimed in claim 11, wherein the charging module transmits a feature signal corresponding to a specific type to a differential signal pair of the USB device, and determines the type of the USB device according to a voltage level from the differential signal pair in response to the feature signal.

13. The electric vehicle as claimed in claim 11, wherein the charging module comprises:
a first detection circuit, configured to determine whether the USB device conforms to a first type;
a control circuit; and
a charging circuit, wherein when the USB device conforms to the first type, the control circuit directs the charging circuit to charge the USB device with a first charging current.

14. The electric vehicle as claimed in claim 13, wherein the first detection circuit provides a first voltage level and a second voltage level to a differential signal pair of the USB device, and determines whether the USB device conforms to the first type by detecting whether voltage levels in the response from the differential signal pair of the USB device are the same with the first voltage level and the second voltage level respectively.

15. The electric vehicle as claimed in claim 13, wherein the charging module further comprises a second detection circuit, and the second detection circuit determines whether the USB device conforms to a second type when the USB device does not conform to the first type,
wherein the control circuit further directs the charging circuit to charge the USB device with a second charging current when the USB device conforms to the second type,
wherein the control circuit further directs the charging circuit to charge the USB device with a third charging current when the USB device does not conform to the second type.

16. The electric vehicle as claimed in claim 15, wherein the second detection circuit provides a third voltage level and a fourth voltage level to the differential signal pair of the USB device, and determines whether the USB device conforms to the second type by detecting whether voltage levels in the response from the differential signal pair of the USB device are the same with the third voltage level and the fourth voltage level.

17. The electric vehicle as claimed in claim 15, wherein the control circuit further short-circuits the differential signal pair when the USB does not conform to the second type, and directs the charging circuit to enter a dedicated charging port mode to charge the USB device with the third charging current at a VBUS pin of the USB device.

18. The electric vehicle as claimed in claim 15, wherein the control circuit further restores the differential signal pair to a connection corresponding to the first type when the charging circuit has charged the USB device with the third charging current for more than a predetermined time period.

19. The electric vehicle as claimed in claims 12, wherein the differential signal pair comprises a D+ pin and a D− pin.

20. The electric vehicle as claimed in claims 14, wherein the differential signal pair comprises a D+ pin and a D− pin.
